(19) United States
(12) Patent Application Publication
(10) Pub. No.: US 2004/0162105 A1
(43) Pub. Date: Aug. 19, 2004

(54) Enhanced general packet radio service (GPRS) mobility management

(76) Inventors: Ramgopal (Paul) K. Reddy, Portland, OR (US); Dhiraj Bhatt, Portland, OR (US)

Correspondence Address: INTEL CORPORATION, P.O. BOX 5326, SANTA CLARA, CA, 95056-5326, US

(21) Appl. No.: 10/663,165

(22) Filed: Sep. 15, 2003

Related U.S. Application Data
(60) Provisional application No. 60/447,665, filed on Feb. 14, 2003.

(51) Int. Cl. H04B 1/38

(52) U.S. Cl. 455/551

(57) ABSTRACT

Requests for credential information from a SIM are initiated using extensible authentication protocol (EAP). A smartcard interface and a SIM reader driver are used to communicate with a GPRS adapter containing the SIM.

### RELATED APPLICATION

This application claims priority to a previously filed provisional application having application serial No. 60/447,665 filed on Feb. 14, 2003.

### FIELD OF THE INVENTION

The present invention relates generally to field of communications. More specifically, the present invention relates to methods and apparatus for managing communications with computer systems.

### BACKGROUND

There are different communications techniques for a mobile device to connect to a network. For example, the mobile device may be equipped with a local area network (LAN) adapter such as an Ethernet adapter to establish a wired connection to the network.

The mobile device may also be equipped with wireless adapters to establish wireless connections to the network. For example, the mobile device may include a wireless local area network (WLAN) adapter to enable a user to connect to a WLAN network such as, for example, an 802.11a/b network. The user may need to provide username and password for authentication and accounting. The authentication may be performed using Remote Authentication Dial In User Service (RADIUS) protocol specified by the Internet Engineering Task Force (IETF) working group. The RADIUS protocol suite includes Authentication and Accounting specifications. These specifications aim to centralize authentication, configuration, and accounting for dial-in services. When dialing in, the communications software in the mobile device sends the username and password to a terminal server. The terminal server in turn sends this information to a RADIUS server. The RADIUS server then queries a RADIUS user database to determine if the user is an authorized user.

The authentication process may be different when accessing a wireless wide area network (WWAN) such as, for example, a General Packet Radio Service (GPRS)/Enhanced GPRS (EGPRS) network. The mobile device may include a GPRS adapter to connect to the GPRS network. The GPRS adapter typically includes a subscriber identity module (SIM). The SIM is unique to a subscriber and includes the subscriber's credential information. The credential information may be used by the GPRS network for authentication and accounting.

### BRIEF DESCRIPTION OF THE DRAWINGS

The present invention is illustrated by way of example, and not limitation, in the figures of the accompanying drawings in which like references indicate similar elements and in which:

FIG. 1 illustrates an example of a network that includes a WLAN and a WWAN, according to one embodiment;

FIG. 2A is a block diagram illustrating an example mobile device having multiple network adapters, according to one embodiment;

FIG. 2B illustrates an example of a SIM;

FIG. 3 is a block diagram illustrating an example of a GPRS adapter appearing as a SIM Smart Card reader device, in accordance with one embodiment;

FIG. 4 illustrates an example of a GPRS adapter power-on start up sequence, in accordance with one embodiment;

FIG. 5 is a flow diagram illustrating a SIM re-use process, in accordance with one embodiment;

FIG. 6 is a flow diagram illustrating another example of a SIM re-use process, in accordance with one embodiment.

FIG. 7 illustrates one example of a computer system having individual GPRS adapter and WLAN adapter, according to one embodiment;

FIG. 8 illustrates one example of a computer system having a combined GPRS adapter and WLAN adapter, according to one embodiment.

### DETAILED DESCRIPTION

For one embodiment, a method to authorize a computer system to connect to a wireless local area network (WLAN) is disclosed. Credential information is provided by a subscriber identity module (SIM) in the computer system. The credential information is sent to the WLAN and the computer system is authenticated.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Overview

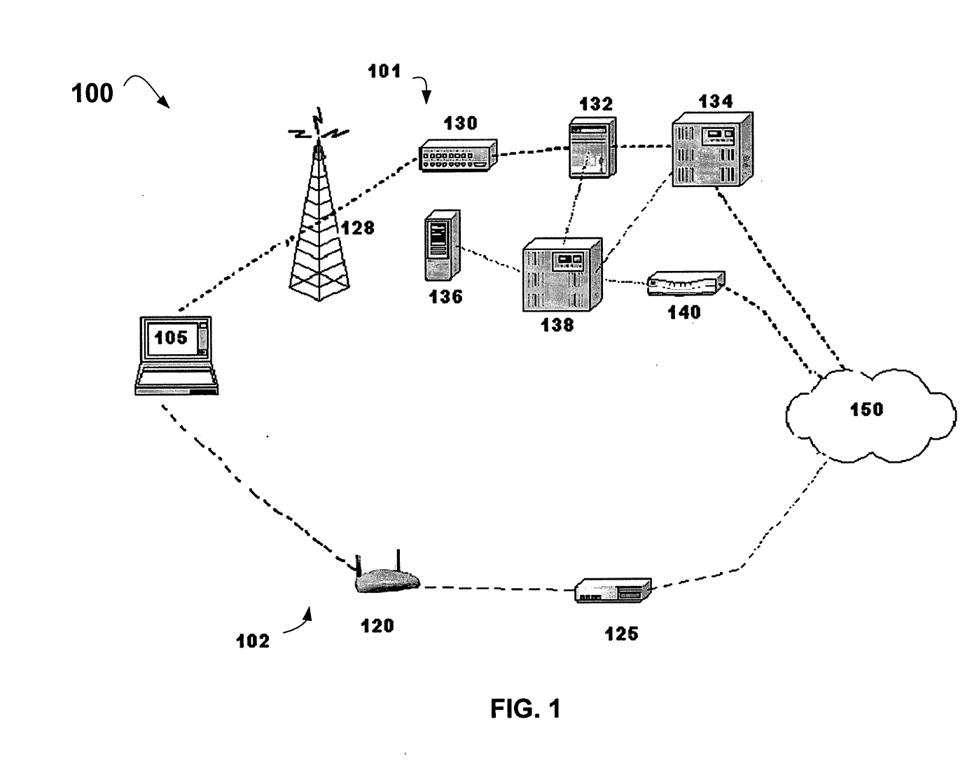

FIG. 1 illustrates an example of a network that includes a wireless local area network (WLAN) and a wireless wide area network (WWAN). Network 100 may include mobile device 105, which may be, for example, a laptop or notebook computer system. The network 100 may include a WWAN such as, for example, a General Packet Radio Service (GPRS) network 101, a wireless local area network (WLAN) 102, and an external network such as, for example, the Internet 150. The mobile device 105 may include more than one network adapter. For example, the mobile device 105 may include a WLAN adapter (not shown) to allow it to establish a WLAN connection to the WLAN 102. The WLAN connection may be established through an access point (AP) 120 (also known as a Wireless Fidelity (Wi-Fi) hotspot), and an authentication, authorization and accounting (AAA) server 125. The AP 120 may offer a wireless Ethernet link between the mobile device 105 and a fixed LAN. The AAA server 125 may perform various functions that may include, for example, gathering accounting information for billing purposes. The AAA server 125 may include gateway functions to connect the WLAN 102 to the Internet 150. The AAA server 125 may allocate IP address to the mobile device 105 and may maintain a list of authenticated devices' IP addresses. The WLAN environment may not be secured because the username and password may be intercepted.

The mobile device 105 may also include a GPRS adapter (not shown) to allow it to establish a WWAN connection to a GPRS network 101. The GPRS network 101 may include a cellular tower 128, a Base Transceiver Station (BTS) 130. The BTS 130 may provide channels for signaling and for data traffic. The BTS 130 may be viewed as an AP in the GPRS network 101. The GPRS network 101 may also include a Serving GPRS Support Node (SGSN) 132 and Gateway GPRS Support Node (GGSN) 134. The SGSN 132 may deliver packets to or from the mobile device 105 within its service area. The SGSN 132 may also provide the security and access control functionalities in the GPRS network 101. The SGSN 132 may perform the authentication procedures, which may include selecting an authentication algorithm. The SGSN 132 may receive the authentication information from the Home Location Register (HLR)Nisitor Location Register (VLR) 138. The HLR/VLR 138 may communicate with the Authentication Center (AuC) 136. The AuC 136 may contain authentication algorithm, keys, etc. which may be used by the HLR/VLR 138.

The SGSN 132 may communicate with the GGSN 134. The GGSN 134 may interface with other external networks (e.g., the Internet 150). Data sent from the mobile device 105 to the Internet 150 may go to the SGSN 132 and the GGSN 134. The GGSN 134 may convert the data for transmission over the appropriate external network. Data from an external network sent to the mobile device 105 may be received by the GGSN 134, forwarded to the SGSN 132, and then transmitted to the mobile device 105. The operations and functionalities of the devices included in the GPRS network 101 and in the WLAN 102 are known to one skilled in the art.

SIM Re-use

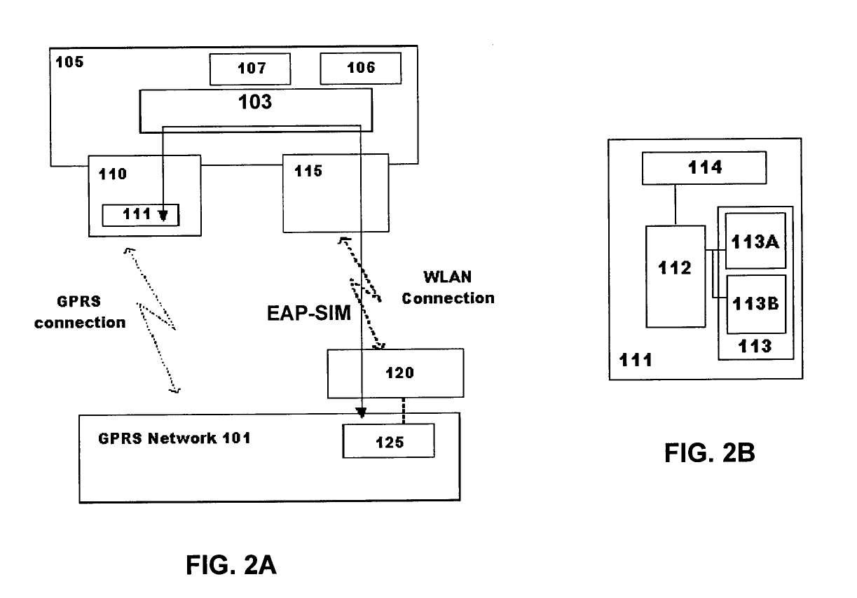

FIG. 2A is a block diagram illustrating an example mobile device having multiple network adapters, according to one embodiment. For one embodiment, the mobile device 105 may include both a GPRS adapter 110 and a WLAN adapter 115. The functionalities of these adapters may be included in modules and/or other forms. For example, the WLAN adapter 115 may exist in several forms such as a USB 802.11 adapter, mini-PCI or PC card form factors, etc. Similarly, the GPRS adapter 110 may exist in several form factors such as, for example, a PC card, a Universal Serial Bus (USB) device, an embedded module, etc. Although not shown, the mobile device 105 may also include a wired LAN adapter such as, for example, a wired Ethernet adapter. The mobile device 105 may also include a Bluetooth adapter or module (not shown). The GPRS adapter 110 may provide the mobile device 105 with a WWAN connection capability. This may be convenient when, for example, wired Ethernet and WLAN connections are not available.

The GPRS adapter 110 may include a SIM 111. The SIM 111 may be fixed or removable. FIG. 2B illustrates an example of a SIM. The SIM 111 may include a processor 112 and a memory 113 (e.g., read only memory (ROM) 113A, random access memory (RAM) 113B). The memory 113 may contain an operating system, applications, security algorithms, secret key, subscriber credential information or identification, etc. The SIM 111 may be considered as a trusted environment having a trusted storage or memory 113 to store, for example, the secret key. The SIM 111 may also include an input/output (I/O) module 114.

For one embodiment, when the mobile device 105 includes a Bluetooth module, the Bluetooth module may also use the credential information stored in the SIM 111. For another embodiment, the connection to the GPRS network 101 may be provided via a Bluetooth connection to a GPRS-enabled phone (not shown).

Presentation of a personal identification number (PIN) may be required to access the credential information in the SIM 111. The security algorithms may be used to implement authentication and encryption based on the subscriber credential information and the secret key (also known as Ki). The SIM 111 and the SGSN 132 may follow some key agreement protocol to exchange information to enable the SGSN 132 to determine if the mobile device 105 is authenticated to use the GPRS network 101. The security functions inside the GPRS network 101 may be based on the secrecy of a secret key in the SIM 111 and in the AuC 136 at subscription time. This secret key may not be known by the subscriber.

For one embodiment, the credential information in the SIM 111 may be re-used to authorize access to the WLAN 102. For example, the mobile device 105 may be authorized using the credential information in the SIM 111 when connecting to the WLAN 102 using the WLAN adapter 115, and when the WLAN 102 is operated by the operator of the GPRS network 101. A standard protocol that is supported in the industry for WLAN authentication is the EAP-SIM protocol (Extensible-Authentication-Protocol), which is an authentication scheme that uses the SIM credential information for authentication. An EAP-SIM client is typically present in the operating system or as a third party add-on software component.

For one embodiment, the GPRS adapter 110 and the WLAN adapter 115 may be used in an “open platform”. In this context, the “open platform” is defined as a system that may allow WLAN client software from independent software vendors to be used on the mobile device 105 along with GPRS adapter 110 from one vendor and the WLAN adapter 115 from possibly another vendor. The use of the SIM credential information for both GPRS and WLAN authentication may allow a single accounting and authentication capability across heterogeneous networks.

SIM Smart Card Reader

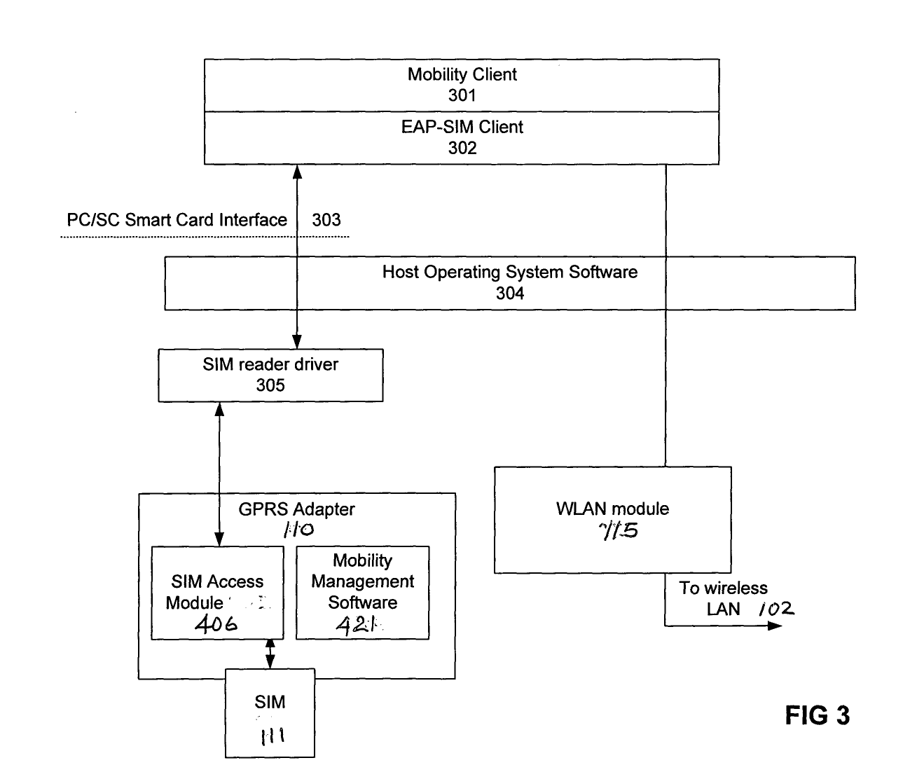

FIG. 3 is a block diagram illustrating an example of a GPRS adapter appearing as a SIM Smart Card reader device, in accordance with one embodiment. The GPRS adapter 110 may include mobility management software (MMS) 421 and a SIM access module (SAM) 406. The GPRS MMS 421 and the SAM 406 help manage the authentication/authorization process and will be described in more detail. For one embodiment, the GPRS adapter 110 may appear as a SIM Smart Card reader device to the host operating system software 304 installed on the mobile device 105. The mobile device 105 may be, for example, a portable computer system, a personal digital assistant (PDA) or other forms of mobile devices.

Access to the SIM 111 within the GPRS adapter 110 may be made available via standard software interfaces 303 such as, for example, the PC card and Smart Card (PC/SC) standard and Open Card Framework (OCF). The PC/SC specification defines a standard mechanism for applications to access PC cards and Smart Cards from reader devices attached to a host device such as the mobile device 105. The PC/SC interface is available to applications running on Microsoft® Windows® XP and some earlier versions of the Windows® operating systems from Microsoft Corporation of Redmond, Wash. The OCF provides another mechanism for Java™ applications to access Smart Cards and PC cards via a standard interface.

Although the physical structure and command/reply interface to a SIM is defined by the GSM 11.11 specification, the command and reply structure is similar to standard Smart Cards that conform to the ISO 7816 specification.

Therefore, it is possible for a GPRS adapter to install itself in a mobile device not only as a network adapter or modem device for network connectivity, but also as a PC/SC compliant Smart Card reader accessible via SIM reader driver software 305. Using a standard interface in an open platform may allow applications such as, WLAN EAP-SIM client 302 from one vendor to access the SIM 111 that may be resident in a SIM reader device from another vendor. The EAP-SIM client 302 may be part of the mobility client 301 of the mobile device 105. Credential information accessed from the SIM 111 may be used by the WLAN module/adapter 115 to access the WLAN 102.

Startup Sequence

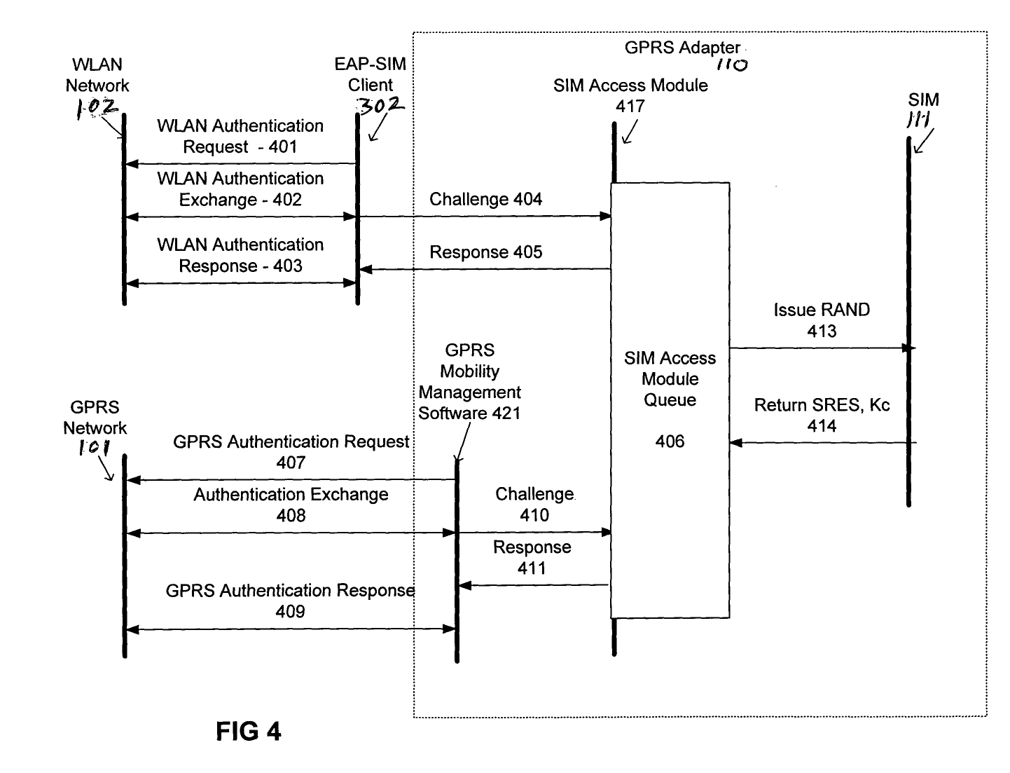

FIG. 4 illustrates an example of a GPRS adapter power-on start up sequence, in accordance with one embodiment. As illustrated in FIG. 4, when the GPRS adapter 110 is powered on, it may go through a startup sequence that may involve network detection, authentication/authorization and registration 407-411 with a preferred network such as for example, the GPRS network 101 (or in some cases a specific network selected by the user). During the authentication and authorization phase 408, any request (challenge) 404 for access to the SIM 111 may be blocked within the GPRS SIM access module (SAM) 417 as commands and replies pertaining to the authentication and authorization are in progress. The SAM 417 is also illustrated in FIG. 3. Each of these operations may be atomic in nature. That is, it may no be interrupted. As illustrated in FIG. 4, this operation may be controlled by the GPRS mobility management software (MMS) 421 within the GPRS adapter 110. The GPRS MMS is also illustrated in FIG. 3. These requests may be from external clients.

For one embodiment, the SAM 417 within the GPRS adapter 110 may implement a SAM queue of commands and replies 406 and controls the command and reply traffic to the SIM 111. The SAM 417 may allow not only the internal GPRS MMS 421 to access the SIM 111, but it may also allow external clients such as, for example, the EAP-SIM WLAN 302 client, to access the SIM 111.

For one embodiment, the SAM 417 may also allow the internal or external clients to define a set of commands that need to be executed atomically in sequence before another set of commands, possibly from another source can be executed. The set of commands to be executed in atomic sequence may be defined as a “command bundle”. The SAM 417 may maintain context for each client (internal and external) that is issuing a command bundle so that the replies can be routed to the client making the request and the atomicity of the command bundle execution sequence for the commands within the bundle may be enforced.

The GPRS MMS 421 controls the registration, authorization/authentication and may cause the SIM 111 to generate Kc (cipher key) 414 and SRES values that are required to be kept intact for the duration of the GPRS connection between the GPRS adapter 110 and the GPRS network 101. The SAM 417 ensures that requests for computation of new SRES and Kc values for WLAN EAP-SIM client 302 for SIM-reuse authentication 401-405 does not result in the values calculated by the GPRS MMS 421 from being changed within the SIM 111. For one embodiment, the SAM 417 in the GPRS adapter 110 may be activated when SIM re-use is required. For example, this may be as a result of a user's attempt to access a WLAN access point (or hot-spot) that requires SIM credential information to be used for WLAN access with the EAP-SIM protocol described above.

When the WLAN adapter (not shown) detects the presence of a WLAN access point, and the user attempts to connect to it, the mobility client 301 may invoke the WLAN EAP-SIM client 302 to authenticate and connect the WLAN adapter to the WLAN network 102. If the WLAN network 102 requires or supports authentication using the SIM 111 via a standard protocol such as, for example, the EAP-SIM protocol, the WLAN EAP-SIM client 302 is invoked. The WLAN EAP-SIM client 302 may enumerate and discover the presence of the SIM 111 in the GPRS adapter 110 via the PC/SC Smart Card interface (not shown).

The WLAN EAP-SIM client 302 may then issue standard PC/SC commands to the SIM 111 to compute the SRES and Kc values in response to a RAND value 413 which is posed by the WLAN authentication server (not shown) as a challenge. The Smart Card reader driver (shown as 305 in FIG. 3) provided by the GPRS adapter vendor may intercept these commands and issue them to the SIM 111 via its device driver interface to the GPRS adapter 110. Within the GPRS adapter 110, the SAM 417 may queue this command in the SAM queue 406 for presentation to the SIM 111 when it is not busy executing one of more set of atomic commands. It may be noted that these commands may need to be executed in strict sequence before another set of commands from another client is executed. The responses 405 are returned back to the EAP-SIM client 302 which then completes the authentication with the WLAN network Authentication server of the WLAN 102.

For one embodiment, the mobility client 301 may register the mobile device 105 with the HLR/VLR 138 (described in FIG. 1). Registration may include providing location information associated with the mobile device 105 and routing information associated with the WLAN 102. For example, the location information may include an identifier associated with the AP 120 and other relevant parameters, as compared to the current Global System for Mobile Communication (GSM) cell identifier (LAI) when using the GPRS network 101. The routing information may include, for example, bandwidth, terminal characteristics, etc. When a database of the HLR/VLR 138 is updated with the routing information of the WLAN 102, the routing information may be used to enable connection for the mobile device q105 over the WLAN 102.

For one embodiment, once the WLAN authentication is complete, a location update is initiated by the WLAN client with the HLR in order to de-register and disconnect the GPRS connection and transfer the data session to the WLAN network connection.

SIM Re-Use Process

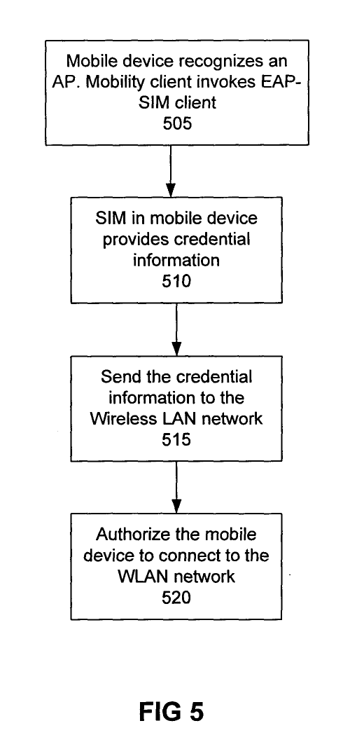

FIG. 5 is a flow diagram illustrating one example of a SIM re-use process, in accordance with one embodiment. At block 505, the mobile device 105 recognizes an access point. This may cause the mobility client 301 to invoke the EAP-SIM client 302. The EAP-SIM client 302 may issue a request or challenge to access the SIM 318. The request may be intercepted by the SAM 417 and may be queued in the SAM queue 406 if the SIM 111 is busy. Once the SIM 111 processes the request, the credential information is provided by the SIM 111, as shown in block 510. At block 515, the credential information is sent to the WLAN 102. At block 520, the mobile device 105 is authorized to connect to the WLAN 102.

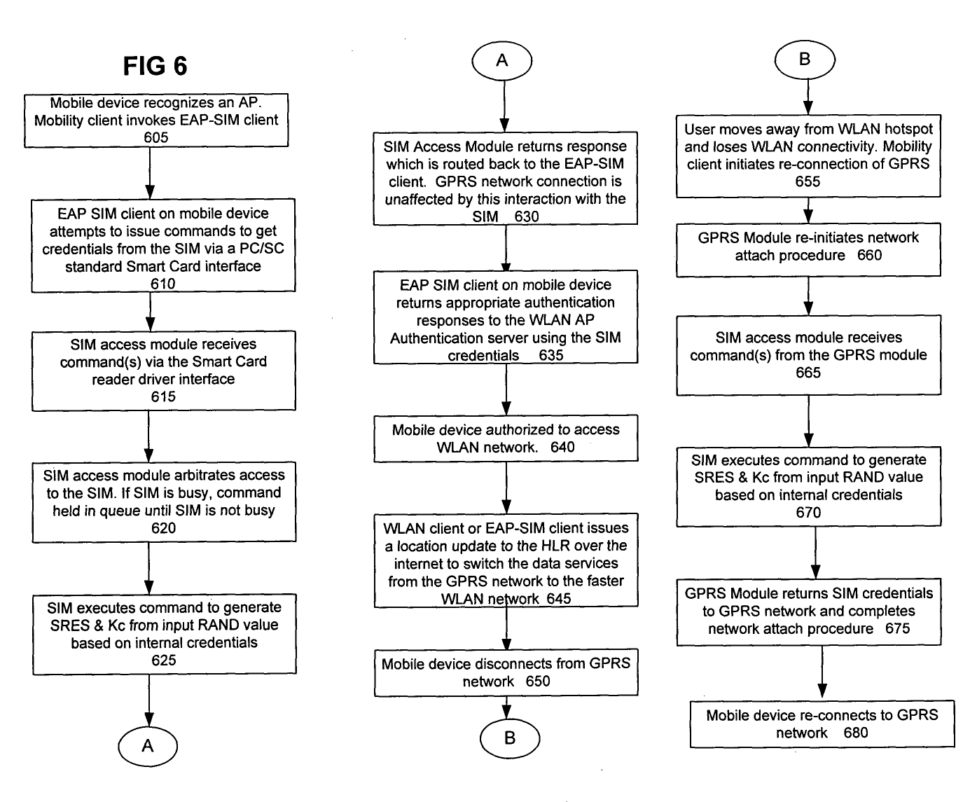

FIG. 6 is a flow diagram illustrating another example of a SIM re-use process, in accordance with one embodiment. The process in FIG. 6 provides one embodiment of how the example in FIG. 5 may be carried out in more detail. At block 605, the mobile device 105 recognizes an access point, and the mobility client 301 invokes the EAP-SIM client 302. At block 610, the EAP-SIM client 302 on the mobile device 105 attempts to issue commands to get the credential information from the SIM 318 via a PC/SC standard Smart Card interface.

At block 615, the SAM 417 receives the command(s) from the EAP-SIM client 302 via the Smart Card interface 303 and the SIM reader driver 305 (illustrated in an example in FIG. 3). The SAM 417 may arbitrate access to the SIM 111. When the SIM 111 is busy, the commands from the EAP-SIM client 302 may be held in the SAM queue 406, as shown in block 620. At block 625, the SIM 111 executes the command to generate SRES and Kc from the input RAND value based on internal credentials. The meaning of SRES, Kc and RAND values are known to one skilled in the art.

At block 630, the SAM 417 returns response which is routed back to the EAP-SIM client 302. It is noted that the GPRS connection may not be affected by the interaction between the EAP-SIM client 302 and the SIM 111. At block 635, the EAP-SIM client 302 on the mobile device 105 returns the appropriate authentication responses to the WLAN AP authentication server using the SIM credential information. At block 640, the mobile device 105 is authorized to connect to and to use the WLAN 102.

At block 645, the mobility client 301 (or WLAN client) or the EAP-SIM client 302 may issues a location update to the HLR/VLR 138 over the Internet to switch the data services from the GPRS network 101 to the faster WLAN 102. At block 650, the mobile device 105 disconnects from the GPRS network 101.

It may be possible that after connecting to the WLAN 102 for a while, the mobile device 105 may be moved away from the access point and lose the WLAN connection to WLAN 102. In this situation, the mobility client 301 may initiate a re-connection with the GPRS network 101, as shown in block 655. At block 660, the GPRS adapter 110 (as illustrated in the example in FIG. 4) re-initiates network attach procedure to establish a GPRS connection to the GPRS network 101.

At block 665, the SAM 417 receives command(s) from the GPRS adapter 110. The command(s) are then passed by the SAM 417 to the SIM 111. AT block 670, the SIM 111 executes command to generate SRES and Kc from the input RAND value based on internal credential information. At block 675, the GPRS adapter 110 returns the SIM credential information to the GPRS network 101 and complete the network attach procedure. At block 680, the mobile device 105 re-connects to the GPRS network 101.

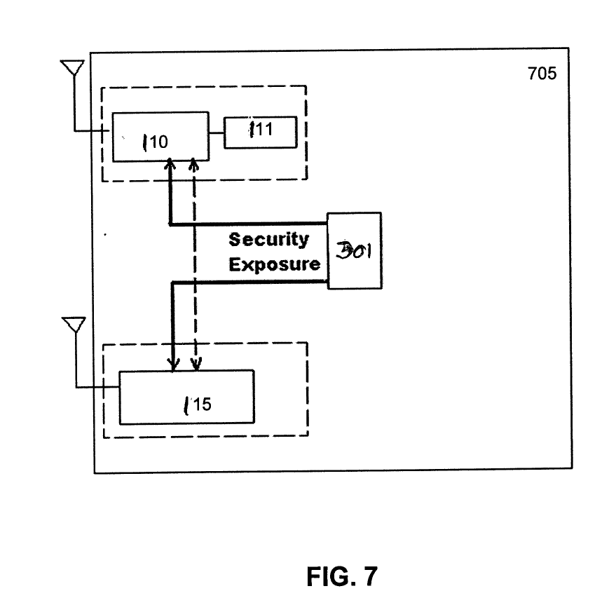

FIG. 7 illustrates one example of a computer system having the SIM re-use capability, in accordance with one embodiment. Computer system 705 includes the GPRS adapter 110 and the WLAN adapter 115 as two separate adapters. In this arrangement, the credential information accessed by the mobility client 301 from the SIM 111 to enable authentication on the WLAN 102 may be exposed to malicious software (e.g., Trojan horses, worms, virus, etc.) while it is being sent to the WLAN adapter 115. Such malicious software may install itself onto the mobile device 105 to trap the authenticated credential information which may cause the user to lose the network connection by not providing the proper authenticated credential information.

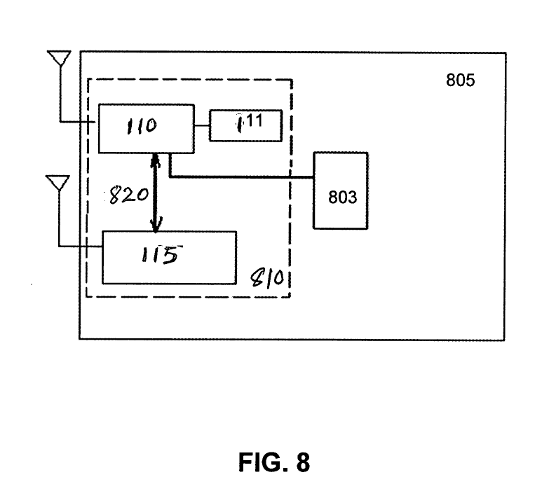

FIG. 8 illustrates one example of another computer system having the SIM re-use capability, according to one embodiment. Computer system 805 includes mobility client 803 and functionalities provided by the GPRS adapter 110 and the WLAN adapter 115. The GPRS adapter 110 includes the SIM 111. For one embodiment, the GPRS adapter 110 and the WLAN 115 may be combined into one module 810. The module 810 may enable having a secure data link 820 between the GPRS adapter 110 and the WLAN adapter 115.

Roaming

The mobile device 105 may be an “always-connected” computer system. Being always-connected may include being able to send and receive information to and from an external network such as, for example, the Internet 150 at any time. For example, referring to FIG. 1, the mobile device 105 may use its GPRS adapter 110 to access the Internet 150 while being near a cellular tower 128. Alternatively, the mobile device 105 may use its WLAN adapter 115 to access the Internet 150 while being within a certain distance from the AP 120.

It may be possible that when the mobile device 105 is connected to the Internet 150 via the GPRS network 101, the mobile device 105 may discover the AP1 20. The AP 120 may be provided by the cellular operator that operates the GPRS network 101. Alternatively, the AP 120 may be provided by a cellular roaming partner at a remote location and who has a roaming agreement with the cellular operator of the home GPRS network 101. For example, the user may be traveling away from the user's home GPRS network 101, and may be located within a certain distance of a remote AP (not shown). In this situation, to enable the user to connect to the remote WLAN (not shown), the authentication may be performed by the remote WLAN and the home GPRS network 101 using the credential information in the SIM 111. In this situation, although the user may not be required to enter the username and password as normally required to connect to a WLAN, the operator of the remote WLAN may have that requirement for verification. Of course, when the remote WLAN is operated by the same operator as the home GPRS network 101, the user may be authenticated with the remote WLAN as if it is the home WLAN 102.

For one embodiment, when there is a currently established GPRS connection, the interaction with the SIM 111 by the mobility client 301 (as illustrated in the example in FIG. 3) for WLAN authentication and authorization may take place without any interruption to the GPRS connection. For another embodiment, when the WLAN connection is established, the GPRS connection may be disconnected by releasing what is known as a packet data protocol (PDP) context which contains the IP address previously granted to the GPRS adapter 110. The GPRS adapter 110 may communicate this event to the operating system (OS) of the mobile device 105 by mimicking a media disconnect, thus breaking the GPRS connection. The switching from the GPRS connection to the WLAN connection may be performed without intervention by the user and with little or no impact to the user applications.

The operations of these various techniques may be implemented by a processor in a computer system, which executes sequences of computer program instructions that are stored in a memory which may be considered to be a machine-readable storage media. The memory may be random access memory, read only memory, a persistent storage memory, such as mass storage device or any combination of these devices. Execution of the sequences of instruction may cause the processor to perform operations according to the process described in FIGS. 5 and 6, for example.

The instructions may be loaded into memory of the computer system from a storage device or from one or more other computer systems (e.g. a server computer system) over a network connection. The instructions may be stored concurrently in several storage devices (e.g. DRAM and a hard disk, such as virtual memory). Consequently, the execution of these instructions may be performed directly by the processor. In other cases, the instructions may not be performed directly or they may not be directly executable by the processor. Under these circumstances, the executions may be executed by causing the processor to execute an interpreter that interprets the instructions, or by causing the processor to execute a compiler which converts the received instructions to instructions that which can be directly executed by the processor. In other embodiments, hard-wired circuitry may be used in place of or in combination with software instructions to implement the present invention. Thus, the present invention is not limited to any specific combination of hardware circuitry and software, or to any particular source for the instructions executed by the computer system.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method, comprising:
using credential information stored in a subscriber identity module (SIM) associated with a General Packet Radio Service (GPRS) adapter to authenticate access to a wireless local area network (WLAN), wherein communications with the SIM is carried out using extensible authentication protocol (EAP).

2. The method of claim 1, further comprising
issuing one or more requests via a smart card interface to get the credential information.

3. The method of claim 2, further comprising:
arbitrating the one or more requests to the SIM when the SIM is busy.

4. The method of claim 3, wherein the one or more requests are received by the SIM via a SIM reader driver.

5. The method of claim 4, further comprising:
receiving the credential information from the SIM after the one or more requests are processed by the SIM.

6. The method of claim 1, further comprising:
establishing a WLAN connection with the WLAN via a WLAN adapter.

7. The method of claim 6, wherein the WLAN connection is established while there is a connection to a GPRS network via the GPRS adapter.

8. The method of claim 7, further comprising:
issuing a location update to switch data services from the GPRS network to the WLAN; and
disconnecting from the GPRS network.

9. A machine-readable medium including machine readable instructions that, if executed by a computer system, cause the computer system to perform a method comprising:
using credential information stored in a subscriber identity module (SIM) associated with a General Packet Radio Service (GPRS) adapter to authenticate access to a wireless local area network (WLAN), wherein communications with the SIM is carried out using extensible authentication protocol (EAP).

10. The machine-readable medium of claim 9, further comprising
issuing one or more requests via a smart card interface to get the credential information.

11. The machine-readable medium of claim 10, further comprising:
arbitrating the one or more requests to the SIM when the SIM is busy.

12. The machine-readable medium of claim 11, wherein the one or more requests are received by the SIM via a SIM reader driver.

13. The machine-readable medium of claim 12, further comprising:
receiving the credential information from the SIM after the one or more requests are processed by the SIM.

14. The machine-readable medium of claim 9, further comprising:
establishing a WLAN connection with the WLAN via a WLAN adapter.

15. The machine-readable medium of claim 14, wherein the WLAN connection is established while there is a connection to a GPRS network via the GPRS adapter.

16. The machine-readable medium of claim 15, further comprising:
issuing a location update to switch data services from the GPRS network to the WLAN; and
disconnecting from the GPRS network.

17. A system, comprising:
a wireless local area network (WLAN) adapter;
a general packet radio service (GPRS) adapter coupled to the WLAN adapter and including a subscriber identify module (SIM); and
a mobility client to initiate requests for credential information from the SIM to authenticate access to a WLAN when the mobility recognizes an access point, wherein said requests for the credential information are communicated to the SIM using extensible authentication protocol (EAP).

18. The system of claim 17, wherein the requests for the credential information are communicated to the SIM via a smart card interface.

19. The system of claim 18, wherein the requests for the credential information are received by the SIM via a SIM reader driver.

20. The system of claim 19, wherein the GPRS adapter includes a SIM access module (SAM) to arbitrate the request for the credential information to the SIM.

21. The system of claim 20, wherein the SAM arbitrates the requests for the credential information to the SIM while there is a GPRS connection to a GPRS network via the GPRS adapter.

22. The system of claim 21, wherein the mobility client is further to issue a location update after the access to the WLAN is authenticated and a WLAN connection is established.

23. The system of claim 22, wherein the mobility client is further to drop the GPRS connection.

25. The system of claim 17, wherein the WLAN adapter and the GPRS adapter are installed an open platform.

26. The system of claim 17, wherein the WLAN adapter and the GPRS adapter are combined into one module.

27. A system, comprising:
means for initiating requests for credential information from a subscriber identity module (SIM) associated with a general packet radio service (GPRS) adapter;
means for authenticating access to a wireless local area network (WLAN) using the credential information; and
means for switching data services from a GPRS connection to a WLAN connection after the access to the WLAN is authenticated.

28. The system of claim 27, wherein said means for requesting the credential information from the SIM includes means for arbitrating requests to the SIM.

29. The system of claim 28, wherein said means for switching data services between the GPRS connection and the WLAN connection includes means for performing a location update.

30. The system of claim 27, further comprising:
means for interfacing with the SIM to send the request for the credential information.
